(19) United States
(12) Patent Application Publication
(10) Pub. No.: US 2014/0373301 A1
(43) Pub. Date: Dec. 25, 2014

(54) WIPER BLADE

(71) Applicant: KCW Corporation, Daegu (KR)

(72) Inventors: Kwan Hee KIM, Daegu (KR); Jae Hyuck AN, Daegu (KR); Woo Sung LEE, Daegu (KR)

(21) Appl. No.: 14/306,841

(22) Filed: Jun. 17, 2014

(30) Foreign Application Priority Data
Jun. 21, 2013 (KR) 10-2013-0071384

(51) Int. Cl. B60S 1/38

(52) U.S. Cl. CPC B60S 1/3801; B60S 2001/3813; B60S 2001/3818
USPC 15/250.453

(57) ABSTRACT

A wiper strip is supported by at least one pair of auxiliary levers coupled to a pair of main levers having a pair of through-holes; a central cover coupled to the main lever is connected to a wiper arm and includes a pair of inner ribs extending in a longitudinal direction and having one upwardly extending end closer to the center of the wiper blade; a spacer clip is inserted between the main lever and the central cover and includes a pair of inner protrusions. As a lower portion of the spacer clip is located on the inner rib, the spacer clip is coupled to the central cover. As the inner protrusions are inserted into the through-hole, the spacer clip is coupled to the main lever. Movement of the spacer clip toward the center of the wiper blade is limited by the extended end of the inner rib.

### CROSS REFERENCE TO RELATED APPLICATIONS

The present application claims priority under 35 U.S.C. §119 to Korean Patent Application No. 10-2013-0071384 filed on Jun. 21, 2013, the disclosure of which is incorporated herein by reference in its entirety.

### FIELD OF THE INVENTION

This embodiment relates to a wiper blade.

### BACKGROUND OF THE INVENTION

In general, a wiper which is installed on the outside of the windshield and rear window, which au front and rear windows of a vehicle respectively, is used to remove remaining rainwater or impurities in order to ensure visibility of a driver of the vehicle when it rains or snows. A driving force of a wiper driving motor installed in the vehicle is transferred to a wiper arm through a linkage, so that the wiper arm performs a repetitive reciprocating movement in the form of a fan. As a result, a wiper blade connected to the front end of the wiper arm removes down-flowing rainwater or other impurities.

In other words, when the driver has a difficulty in ensuring visibility due to the rain, snow or dust during the driving of the vehicle, the wiper is operated by the operation of the driver, and then, the wiper blade of the end of the wiper arm is pivoted simultaneously when the wiper arm is pivoted by the driving of the motor, so that the window is cleaned by a blade rubber of the end of the wiper blade.

### SUMMARY OF THE INVENTION

One embodiment is a wiper blade 10 that includes: a wiper strip 100 which wipes a glass surface; at least one pair of auxiliary levers 200 which supports the wiper strip 100; a pair of resin-made main levers 300 which is coupled to the auxiliary levers 200 and includes a pair of right and left second through-holes 350 formed in a side thereof; a central cover 600 which is coupled to the main lever 300, is connected to a wiper arm and includes a pair of right and left inner ribs 640 extending from the inside of the central cover 600 in a longitudinal direction of the central cover 600 and having one end closer to the center of the wiper blade 10, the one end extending upwardly; and a resin-made spacer clip 400 which is inserted between the main lever 300 and the central cover 600 and includes a pair of right and left inner protrusions 410 formed therewithin. In a state where a lower portion of the spacer clip 400 is located on the inner rib 640, the spacer clip 400 is coupled to the central cover 600. As the inner protrusion 410 is inserted into the second through-hole 350, the spacer clip 400 is coupled to the main lever 300. The movement of the spacer clip 400 toward the center of the wiper blade 10 is limited by the extended end of the inner rib 640.

The central cover 600 may include a pair of right and left catching grooves 650 formed under and outside the other end of the inner rib 640. The spacer clip 400 may include a pair of right and left catching protrusions 420 which has a shape protruding outward from the spacer clip 400 and is inserted into the catching groove 650. In a state where the lower portion of the spacer clip 400 is located on the inner rib 640, the spacer clip 400 may be coupled to the central cover 600 as the catching protrusion 420 is inserted into the catching groove 650.

The central cover 600 may further include a pair of right and left open grooves 645 formed on and outside the other end of the inner rib 640. The spacer clip 400 further includes a pair of right and left outer protrusions 430 which has a shape protruding outward from the spacer clip 400 and moves limitedly toward the center of the wiper blade 10 by the open groove 645.

The catching protrusion 420 may be formed to have a degree of projection, which is increased toward an end of the spacer clip 400 from the center of the wiper blade 10.

The central cover 600 may include a pair of right and left catching protrusions 660 which has a protruding shape and is formed outwardly and downwardly from the other end of the inner rib 640. The spacer clip 400 may include a pair of right and left catching grooves 425 into which the catching protrusion 660 is inserted. In a state where the lower portion of the spacer clip 400 is located on the inner rib 640, the spacer clip 400 may be coupled to the central cover 600 as the catching protrusion 660 is inserted into the catching groove 425.

The central cover 600 may further include a pair of right and left open grooves 645 formed on and outside the other end of the inner rib 640. The spacer clip 400 may further include a pair of right and left outer protrusions 430 which has a shape protruding outward from the spacer clip 400 and moves limitedly toward the center of the wiper blade 10 by the open groove 645.

The catching protrusion 420 may be formed to have a degree of projection, which is increased toward an end of the spacer clip 400 from the center of the wiper blade 10.

Another embodiment is a wiper blade 10 that includes: a wiper strip 100 which wipes a glass surface; at least one pair of auxiliary levers 200 which supports the wiper strip 100; a pair of resin-made main levers 300 which is coupled to the auxiliary levers 200 and includes a pair of right and left second through-holes 350 formed in a side thereof; a central cover 600 which is coupled to the main lever 300, is connected to a wiper arm and includes a pair of right and left inner ribs 640 extending from the inside of the central cover 600 in a longitudinal direction of the central cover 600; and a resin-made spacer clip 400 which is inserted between the main lever 300 and the central cover 600 and includes a pair of right and left outer ribs 440 formed to extend from an outer surface of the spacer clip 400 in a longitudinal direction of the spacer clip 400 and a pair of right and left inner protrusions 410′ formed therewithin. In a state where the outer rib 440 is inserted into the slit 655, the spacer clip 400 is coupled to the central cover 600. As the inner protrusion 410′ is inserted into the second through-hole 350, the spacer clip 400 is coupled to the main lever 300.

The central cover 600 may include a pair of right and left catching grooves 650′ formed under and outside the other end of the inner rib 640. The spacer clip 400 may include a pair of right and left catching protrusions 420′ which has a shape protruding outward from the spacer clip 400 and is inserted into the catching groove 650′. In a state where the outer rib 440 is inserted into the slit 655, the spacer clip 400 may be coupled to the central cover 600 as the catching protrusion 420′ is inserted into the catching groove 650′.

The catching protrusion 420′ may be formed to have a degree of projection, which is increased toward an end of the spacer clip 400 from the center of the wiper blade 10.

The central cover 600 may include a pair of right and left catching protrusions 660 which has a protruding shape and is formed outwardly and downwardly front the other end of the inner rib 640. The spacer clip 400 may include a pair of right and left catching grooves 425 into which the catching protrusion 660 is inserted. In the state where the outer rib 440 is inserted into the slit 655, the spacer clip 400 may be coupled to the central cover 600 as the catching protrusion 660 is inserted into the catching groove 425.

Further another embodiment is a wiper blade that includes:

a wiper strip 100 which wipes a glass surface; at least one pair of auxiliary levers 200 which supports the wiper strip 100; a pair of resin-made main levers 300 which is coupled to the auxiliary levers 200 and includes a pair of right and left outer protrusions 365 formed on the outside thereof; a central cover 600 which is coupled to the main lever 300, is connected to a wiper arm and includes a pair of right and left slits 655 extending front the inside of the central cover 600 in a longitudinal direction of the central cover 600, and includes a pair of right and left catching grooves 650′ formed therewithin; and a resin-made spacer clip 400 which is inserted between the main lever 300 and the central cover 600 and includes a pair of right and left outer ribs 440 formed to extend from an outer surface of the spacer clip 400 in a longitudinal direction of the spacer clip 400, includes a pair of right and left through-holes 435 formed on sides thereof, and includes a pair of right and left catching protrusions 420′ which protrudes outwardly from the outer surface of the spacer clip 400. In a state where the outer rib 440 is inserted into the slit 655, the spacer clip 400 may be coupled to the central cover 600 as the catching protrusion 420′ is inserted into the catching groove 650′. As the outer protrusion 365 is inserted into the through-hole 435, the spacer clip 400 may be coupled to the main lever 300.

### BRIEF DESCRIPTION OF THE DRAWINGS

Arrangements and embodiments may be described in detail with reference to the following drawings in which like reference numerals refer to like elements and wherein:

FIG. 1 is a front view of a wiper blade 10 according to a first embodiment;

FIG. 2 is a top perspective view of the wiper blade 10 shown in FIG. 1;

FIG. 3 is a bottom perspective view of the wiper blade 10 shown in FIG. 1;

FIG. 4 is an exploded front view of the wiper blade 10 shown in FIG. 1;

FIG. 5 is an exploded perspective view of the wiper blade shown in FIG. 2;

FIG. 6 is an exploded perspective view of the wiper blade shown in FIG. 3;

FIG. 7a is an exploded perspective view of an end of a wiper strip 100 of FIG. 1;

FIG. 7b is an exploded perspective view of the other end of the wiper strip 100 of FIG. 1;

FIG. 8 shows enlarged views of a main lever 300, a spacer clip 400 and a central cover 600 in the wiper blade 10 shown in FIG. 2;

FIGS. 9a to 9g show enlarged views of the spacer clip 400 according to the first example;

FIGS. 10a to 10b show enlarged views of the central over 600 according to the first example;

FIGS. 11a to 11d show enlarged views of a spacer clip 400′ according to a second example;

FIGS. 12a to 12d show enlarged views of a central cover 600′ according to the second example;

FIG. 13a shows an enlarged view of a first modified example 400″ of the spacer clip according to the first example;

FIG. 13b shows an enlarged view of a first modified example 600″ of the central cover according to the first example;

FIG. 13c is a view showing a coupling relationship between the spacer clip 400″ of FIG. 13a and the central cover 600″ of FIG. 13b;

FIG. 14 is a view showing a coupling relationship between a main lever 300′″ and a spacer clip 400′″ according to a second modified example of the first example;

FIG. 15 is an exploded front view of a wiper blade 10′ according to the second embodiment;

FIG. 16 is a top perspective view of the wiper blade 10′ according to the second embodiment; and

FIG. 17 is a bottom perspective view of the wiper blade 10′ according to the second embodiment.

### DETAILED DESCRIPTION OF THE INVENTION

A thickness or a size of each layer may be magnified, omitted or schematically shown for the purpose of convenience and clearness of description. The size of each component may not necessarily mean its actual size.

It should be understood that when an element is referred to as being ‘on’ or “under” another element, it may be directly on/under the element, and/or one or more intervening elements may also be present. When an element is referred to as being ‘on’ or ‘under’, ‘under the element’ as well as ‘on the element’ may be included based on the element.

An embodiment may be described in detail with reference to the accompanying drawings.

### Wiper Blade 10 According to a First Embodiment

### 1. Overall Structure

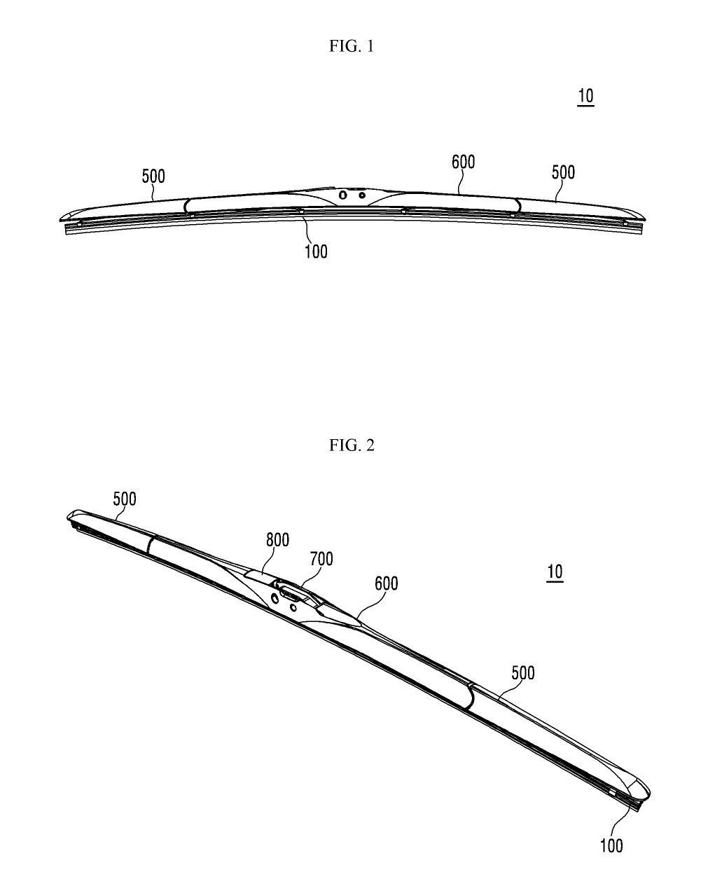

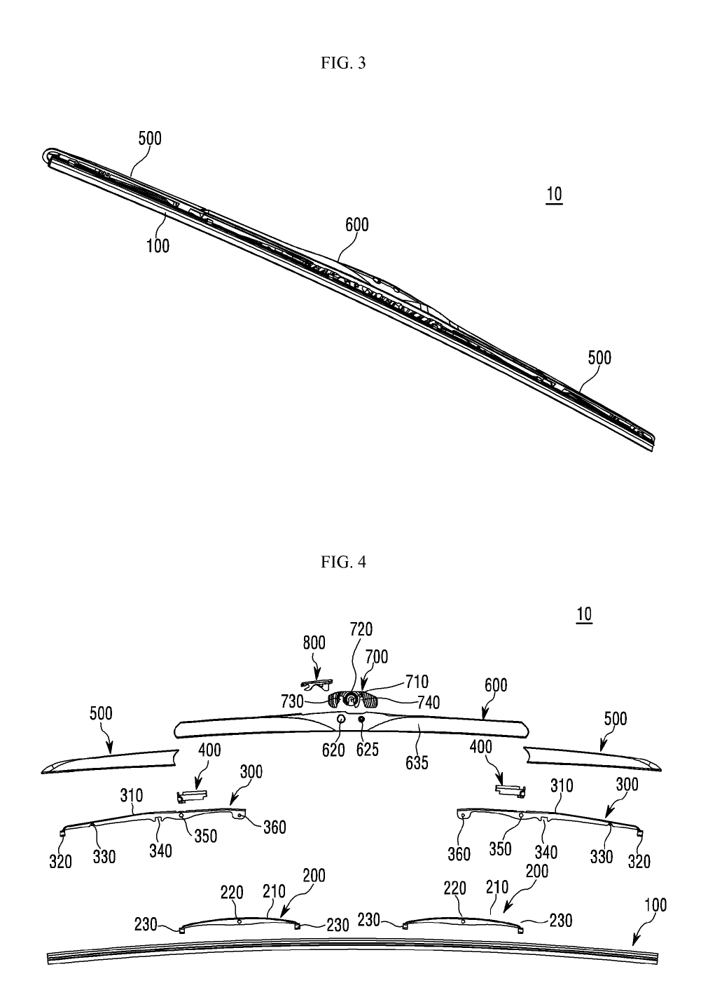

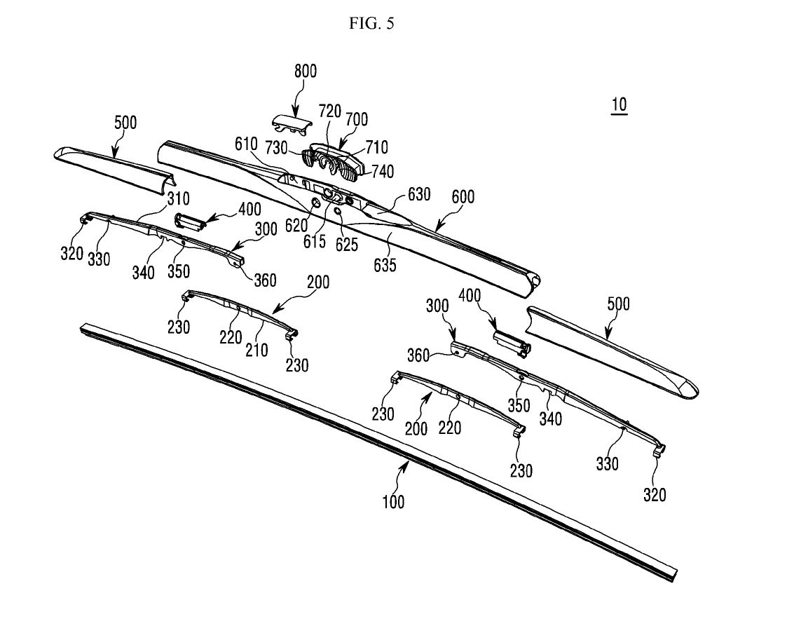

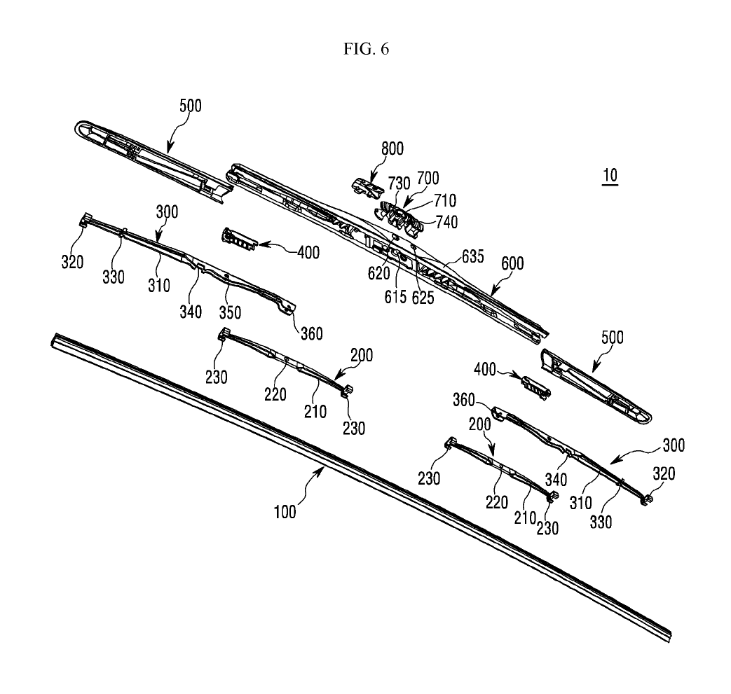

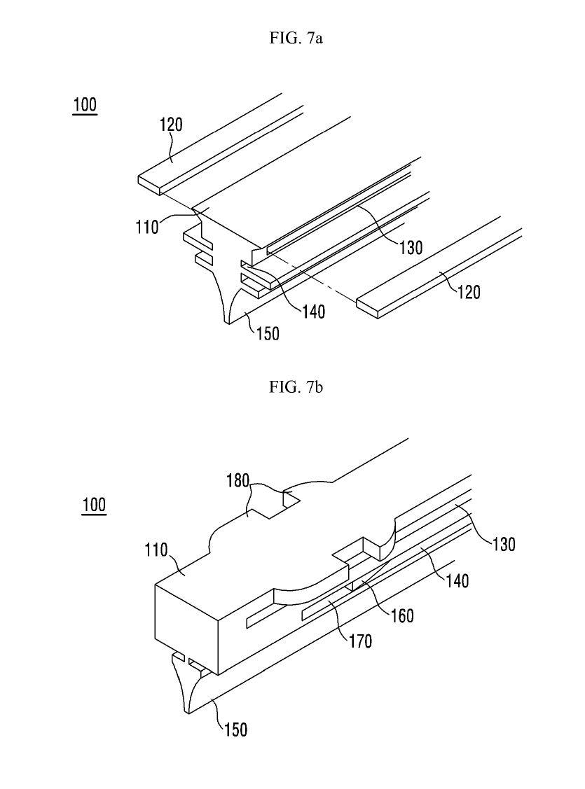

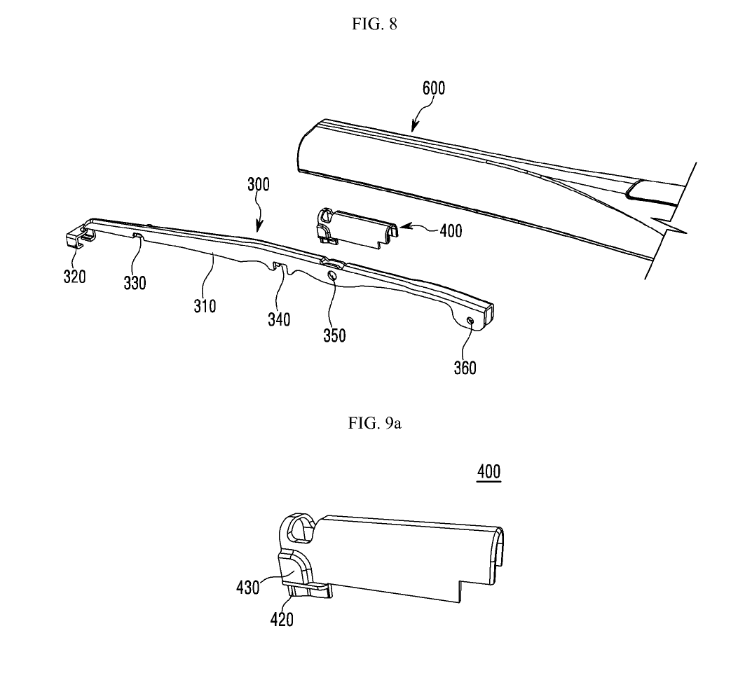

FIG. 1 is a front view of a wiper blade 10 according to a first embodiment. FIG. 2 is a top perspective view of the wiper blade 10 shown in FIG. 1. FIG. 3 is a bottom perspective view of the wiper blade 10 shown in FIG. 1. FIG. 4 is an exploded front view of the wiper blade 10 shown in FIG. 1. FIG. 5 is an exploded perspective view of the wiper blade 10 shown in FIG. 2. FIG. 6 is an exploded perspective view of the wiper blade 10 shown in FIG. 3.

Hereafter, the overall structure and each component of the wiper blade 10 according to the first embodiment will be described in detail with reference to FIGS. 1 to 6.

Referring to FIGS. 1 to 6, the wiper blade 10 according to the first embodiment may be connected to a front end of a wiper arm (not shown) and may receive a pressing force from the wiper arm (not shown) with respect to a glass surface (a wiping surface) of a vehicle. The wiper arm (not shown) may perform reciprocating rotation at a certain angle by a wiper motor (not shown). The wiper blade 10 connected to the front end of the wiper arm (not shown) may rotate at a certain angle in accordance with the rotation of the wiper arm (not shown). The wiper blade 10 may wipe the glass surface of the vehicle within a range of a certain angle.

The wiper blade 10 according to the first embodiment may include a wiper strip 100, a pair of auxiliary levers 200, a pair of main levers 300, a pair of spacer clips 400, a pair of side covers 500, a central cover 600, an adaptor 700 and a covering member 800.

The wiper strip 100 may wipe by contacting with the glass surface of the vehicle.

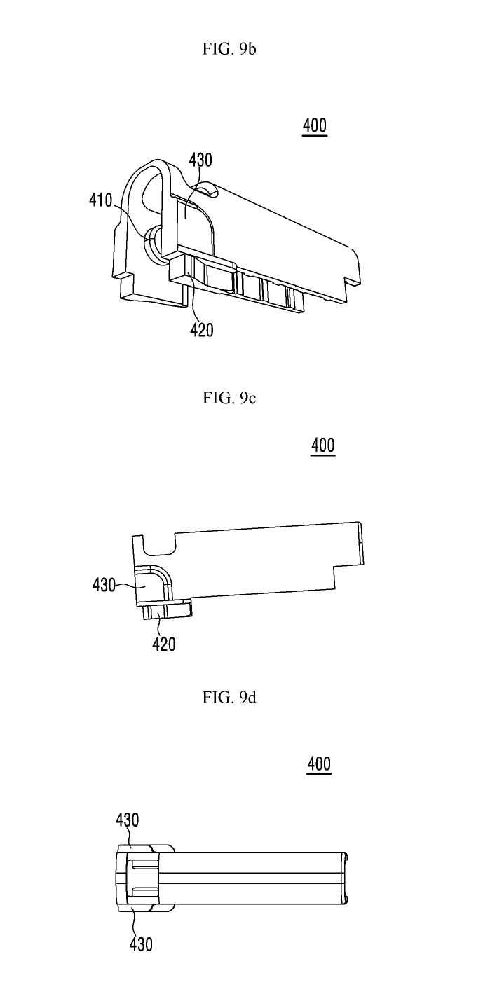

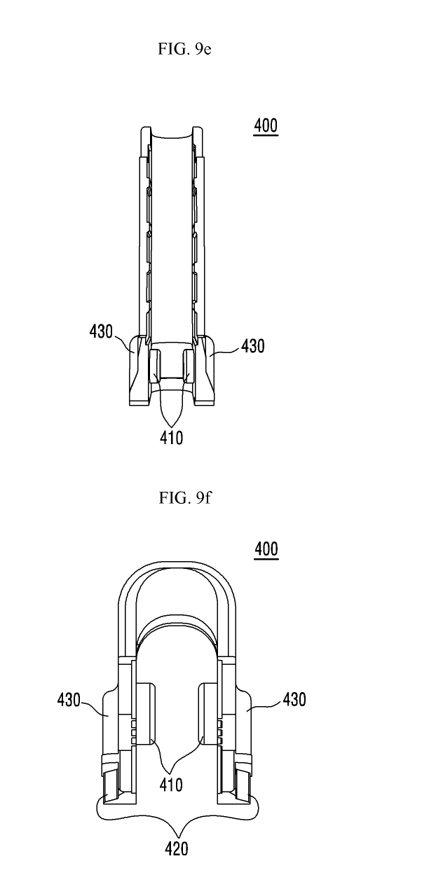

FIG. 7a is an exploded perspective view of an end of a wiper strip 100 of FIG. 1. FIG. 7b is an exploded perspective view of the other end of the wiper strip 100 of FIG. 1. Hereafter, the structure of the wiper strip 100 will be described with reference to FIGS. 7a and 7b. More specifically, the structures of one and the other ends of the wiper strip 100 having a certain length will be described in detail.

As shown in FIG. 7a, one end of the wiper strip 100 may include a base 110, a pair of backing plates 120, a backing plate receiving groove 130, a holder 140 and a wiping lip 150. Also, as shown in FIG. 7b, the other end of the wiper strip 100 may further include a block 160, a coupler 170, and a protrusion 180 as well as the base 110, a pair of the backing plates 120, the backing plate receiving groove 130, the holder 140, and the wiping lip 150.

The base 110 may extend continuously in the longitudinal direction of the wiper strip 100. The length of the base 110 may correspond to the length of the wiper strip 100. The base 110 may be supported by the auxiliary lever 200 and the main lever 300. More specifically, the base 110 may be supported by a pair of first fasteners 230 formed on both sides of the auxiliary lever 200 and a second fastener 320 formed on one end of the main lever 300.

A shape of the backing plate 120 may be a rectangular, and the backing plate 120 may have elasticity and strength. Therefore, a metallic material having the elasticity and strength may be used as the material of the backing plate 120. The backing plate 120 has a length less than that of the wiper strip 100. The backing plate 120 may be composed of one pair having the same length.

The backing plate 120 may be received in the backing plate receiving groove 130 formed in the lower portion of the base 110 and be coupled to the wiper strip 100. Also, the backing plate 120 may be separated from the backing plate receiving groove 130. A pair of the backing plates 120 may be received respectively in a pair of the backing plate receiving grooves 130.

Due to the backing plate 120, the wiper strip 100 has the elasticity and strength for maintaining the shape thereof. The pressing force transferred from the wiper arm (not shown) may be distributed to the wiper strip 100 through the main lever 300 and the auxiliary lever 200. The pressing, force which is distributed to the wiper strip 100 may be evenly distributed in the longitudinal direction of the wiper strip 100 by the backing plate 120. Therefore, wiper strip 100 is able to maintain a certain shape.

The central portion of the backing plate 120 may have a certain curvature in a direction of being separated from the glass surface. When the glass surface has a curvature, the backing plate 120 may have a curvature corresponding to the curvature of the glass surface. More specifically, the curvature of the backing plate 120 may be larger than the curvature of the glass surface. In other words, the curvature radius of the backing plate 120 may be less than that of the glass surface.

Though FIGS. 7a and 7b show a pair of the backing plates 120 and a pair of the backing plate receiving grooves 130, they are not necessarily limited to this. Depending on the strength or elasticity of the wiper strip 100, two or more pairs of the backing plates 120 and two or more pairs of the backing plate receiving groove 130 may be provided.

The backing plate receiving groove 130 may be provided in both sides of the base 110 in the longitudinal direction of the base 110 and may extend continuously in the longitudinal direction of the wiper strip 100. Here, the backing plate receiving groove 130 may have a depth corresponding to the width of the backing plate 120, a height corresponding to the thickness of the backing plate 120, and a length corresponding to the length of the backing plate 120. Therefore, the backing plate receiving groove 130 may have a length less than that of the base 110.

The holder 140 is disposed in the lower portion of the backing plate receiving groove 130 and may extend continuously in the longitudinal direction of the wiper strip 100. The holder 140 may have a shape which may be open to one end of the wiper strip 100 and not be open to the other end of the wiper strip 100. A pair of the first fasteners 230 formed in one auxiliary lever 200, and a pair of the second fasteners 320 formed in one main lever 300 may be slidably received in the open type holder 140 formed in one end of the wiper strip 100. That is, as a whole, two pairs of the first fasteners 230 and a pair of the second fasteners 320 may be received in the holder 140 in a sliding manner.

The other end of the wiper strip 100 may include the block 160, the coupler 170, and the protrusion 180. The second fastener 320 of the main lever 300 may be inserted into the coupler 170 and may be fixed by the block 160. Also, the second fastener 320 may move limitedly in the longitudinal direction of the wiper strip 100 by the block 160 and the protrusion 180.

The wiping lip 150 is disposed to slidably contact with the glass surface of the vehicle, thereby removing impurities on the glass surface. The wiping lip 150 may extend in the longitudinal direction of the wiper strip 100 and may include elastic material or elastic composite material, for example, rubber material.

Referring back to FIGS. 1 to 6, a pair of the auxiliary levers 200, a pair of the main levers 300, a pair of the spacer clips 400, and a pair of the side covers 500 are disposed symmetrically with respect to the central cover 600, and the structures and functions of the components of each pair may be the same as each other. Therefore, one auxiliary lever 200, one main lever 300, one spacer clip 400, and one side cover 500 will be described and descriptions of the others will be omitted.

The auxiliary lever 200 may include a first body 210, a first through-hole 220, and a pair of the first fasteners 230. As shown in FIGS. 1 to 6, a pair of the auxiliary levers 200 is disposed symmetrically with respect to the central cover 600. Hereafter, since the auxiliary levers 200 of a pair of the auxiliary levers 200 have the same structure, only one auxiliary lever 200 will be described.

The first body 210 may have a certain length. The first through-hole 220 may be located in the center of the first body 210. A pair of the first fasteners 230 may be located on both ends of the first body 210. The first body 210 may be symmetrical with respect to the first through-hole 220. The auxiliary lever 200 may be made by performing a pressing process on a metal plate. The central portion of the first body 210 of the auxiliary lever 200 may have a convex arched shape. The first through-hole 220 may be formed in the width direction of the auxiliary lever 200. Also, the first body 210 may have a U-shaped cross section having an open bottom.

A pair of the first fasteners 230 of the auxiliary lever 200 is received in the holder 140 of the wiper strip 100, and then supports the wiper strip 100. Since a pair of the first fasteners 230 is received in the holder 140 of the wiper strip 100, the first fastener 230 of the auxiliary lever 200 is able to support two points of the wiper strip 100. Here, a pair of the first fasteners 230 is able to support the wiper strip 100 in such a manner as to slidably move in the wiper strip 100. Also, since a pair of the auxiliary levers 200 is present, the first fastener 230 of the auxiliary lever 200 is able to support four points of the wiper strip 100 as a whole. Further, the auxiliary lever 200 may include a resin material. When the auxiliary lever 200 includes a resin material, the entire wiper blade 10 may be lighter.

The main lever 300 may include a second body 310, the second fastener 320, a first connection groove 330, a second connection groove 340, a second through-hole 350, and a third through-hole 360. In the second body 310, a length from the second through-hole 350 to the second fastener 320 may be greater than a length from the second through-hole 350 to the third through-hole 360. Also, the second body 310 of the main lever 300 may have a length greater than that of the first body 210 of the auxiliary lever 200. Further, the main lever 300 may be made of a resin material. When the main lever 300 is made of a resin material the entire wiper blade 10 may be lighter.

The auxiliary lever 200 may be coupled to the main lever 300. The auxiliary lever 200 and the main lever 300 may be hinge-coupled to each other. More specifically, the auxiliary lever 200 may be inserted into the inside of the main lever 300 such that the third through-hole 360 of the main lever 300 and the first through-hole 220 of the auxiliary lever 200 are located at the same position. Under the state where the auxiliary lever 200 is inserted into the inside of the main lever 300, a connecting pin (not shown) is inserted through both the first through-hole 220 of the auxiliary lever 200 and the third through-hole 360 of the main lever 300, so that the main lever 300 is coupled to the auxiliary lever 200. Here, a spacer (not shown) is inserted between the first through-hole 220 of the auxiliary lever 200 and the third through-hole 360 of the main lever 300, thereby strengthening the coupling of the first through-hole 220 of the auxiliary lever 200 and the third through-hole 360 of the main lever 300. Here, the auxiliary lever 200 may be made of a resin material. The spacer (not shown) may be also made of a resin material.

The auxiliary lever 200 and the main lever 300 are not necessarily coupled to each other by inserting the connection pin (not shown) through the first through-hole 220 and the third through-hole 360. For example, in a structure in which the auxiliary lever 200 has a projection part formed on the outside thereof and the main lever 300 has a hole formed on the inside thereof the auxiliary lever 200 and the main lever 300 are coupled to each other by inserting the projection part formed on the outside of the auxiliary lever 200 into the hole formed on the inside of the main lever 300. The second fastener 320 of the main lever 300 is received in the holder 140 of the wiper strip 100, and then supports the wiper strip 100.

Also, a straight-line distance from the second fastener 320 of the main lever 300 to the first fastener 230 closer to the second fastener 320 among the first fasteners 230 of the auxiliary lever 200 may be the same as a straight-line distance from the second fastener 320 to the second through-hole 350 of the main lever 300. In other words, the first fasteners 230 of the auxiliary lever 200 and the second through-hole 350 of main lever 300 may be perpendicular to each other and on the same plane. Here, the same pressure is applied to the first fastener 230 and the second fastener 320, thereby improving the wiping performance.

The main lever 300 and the auxiliary lever 200 may have a U-shaped cross section having an open bottom. Therefore, the main lever 300 is able to receive a portion of the auxiliary lever 200 in the inside thereof. Since both the main lever 300 and the auxiliary lever 200 have the U-shaped cross section, when a portion of the auxiliary lever 200 is received in the main lever 300, a gap between the main lever 300 and the auxiliary lever 200 can be reduced. Accordingly, the wiping performance can be maintained satisfactory by causing the wide blade 10 to contact more closely with the glass surface.

Two points of the wiper strip 100 are supported by the first fastener 230 of the auxiliary lever 200, and one point of the wiper strip 100 is supported by the second fastener 320 of the main lever 300. Therefore, three points of the wiper strip 100 are supported. Since a pair of the auxiliary levers 200 and a pair of the main levers 300 are provided, so that it is possible to as a whole support six points of the wiper strip 100. As such, since the six points of the wiper strip 100 are supported by the main lever 300 and the auxiliary lever 200, the end of the wiper strip 100 can be sufficiently pressed. Also, the pressing force applied to the wiper strip 100 can be evenly distributed to the six points. Accordingly, the glass surface can be cleaned by the pressing force applied to the wiper strip 100.

The side cover 500 may include a supporting protrusion 510, a first coupling protrusion 520, and a second coupling protrusion 530. The supporting protrusion 510, the first coupling protrusion 520, and the second coupling protrusion 530 of the side cover 500 may be located at positions corresponding to the second fastener 320, the first connection groove 330, and the second connection groove 340 of the main lever 300. The side cover 500 and the main lever 300 may be coupled to each other by the supporting protrusion 510, the first coupling protrusion 520, and the second coupling protrusion 530 of the side cover 500 and the second fastener 320, the first connection groove 330, and the second connection groove 340 of the main lever 300.

In the main lever 300, the upper portion of the second fastener 320 may be supported by the supporting protrusion 510 of the side cover 500. The supporting protrusion 510 prevents the second fastener 320 of the main lever 300 from rotating toward the side cover 500, thereby preventing the transformation caused by the moment of the main lever 300.

The first coupling protrusion 520 may be formed to protrude inwardly from the lower portion of the side cover 500. The first coupling protrusion 520 may form a space for receiving the main lever 300. More specifically, the first coupling protrusion 520 may form a space for receiving the first connection groove 330 of the main lever 300. The lower portion of first connection groove 330 of main lever 300 may have an outwardly curved shape such that the first connection groove 330 is received in the first coupling protrusion 520. The first connection groove 330 is caught by the first coupling protrusion 520, so that the main lever 300 is prevented from being separated from the side cover 500.

The second coupling protrusion 530 may be formed to protrude inwardly from the lower portion of the side cover 500. Here, the protruded surface may be flat. A space for receiving the second connection groove 340 of the main lever 300 may be formed by the second coupling protrusion 530. The second coupling protrusion 530 presses transversely the second connection groove 340 of the main lever 300, and thus, can be elastically coupled to the main lever 300. Also, through this coupling, the main lever 300 is prevented from being separated from the side cover 500.

The central cover 600 may include an opening 610, a central shaft 615, a first pin hole 620, a second pin hole 625, a first concave part 630, and a second concave part 635.

The opening 610 may be formed to open both the upper and lower portions of the central cover 600 in the central portion of the central cover 600. The central shaft 615 may be formed in the center of the opening 610 and traverse in the width direction of the opening 610. The first pin hole 620 and the second pin hole 625 which have a certain size may be formed in the central lateral side of the central cover 600. Here, the sizes of the first pin hole 620 and the second pin hole 625 may be changed according to the size of the wiper arm (not shown).

The first concave part 630 may be formed concave in a portion of the top surface of the central cover 600 in a direction of the wiper strip 100. The first concave part 630 may have a shape which is obliquely concave in a direction from the top to the bottom of the central cover 600 and in a direction from the center to the end of the wiper blade 10. When the central cover 600 is coupled to and pivoted with a U-hook type wiper arm, the first concave part 630 can prevent interference.

In at least one of both sides of the central cover 600 in such a manner as to be toward the bottom, the second concave part 635 may be formed concave toward the bottom. When the central cover 600 is coupled to and pivoted with a side pin hole type wiper arm, the second concave pan 635 can prevent that the pivot is interrupted by interference caused by the side of the central cover 600 and the wiper arm (not shown).

The adaptor 700 may include a shaft coupling groove 710, a U-hook coupler 720, a first coupling groove 730, and a second coupling groove 740.

The adaptor 700 may be assembled to the central cover 600 and directly connected to the wiper arm (not shown). The shaft coupling groove 710 of the adaptor 700 is inserted into the central shaft 615 of the central cover 600, so that the adaptor 700 can be assembled to the central cover 600.

The first coupling groove 730 may be formed at a position corresponding to that of the first pin hole 620. More specifically, when the adaptor 700 is assembled to the central cover 600, the first coupling groove 730 may be formed at a position corresponding to that of the first pin hole 620. The second coupling groove 740 may be formed at a position corresponding to that of the second pin hole 625. More specifically, the when the adaptor 700 is assembled to the central cover 600, the second coupling groove 740 may be formed at a position corresponding to that of the second pin hole 625.

The adaptor 700 may be formed to receive both the U-hook type wiper arm and the side pin hole type wiper arm. The U-hook type wiper arm may be coupled to the U-hook coupler 720 which has a curved surface. The side pin hole type wiper arm may be coupled to the first pin hole 620 and the second pin hole 625. The covering member 800 is able to block the opening 610 by being coupled to the opening 610.

The central cover 600 may be coupled to the main lever 300. More specifically, the main lever 300 is inserted into the inside of the central cover 600. Here, the spacer clip 400 is inserted between the central cover 600 and the main lever 300, thereby strengthening the coupling of the central cover 600 and the main lever 300.

2. The Coupling of the Main Lever 300 and the Central Cover 600 in Accordance with the First Example

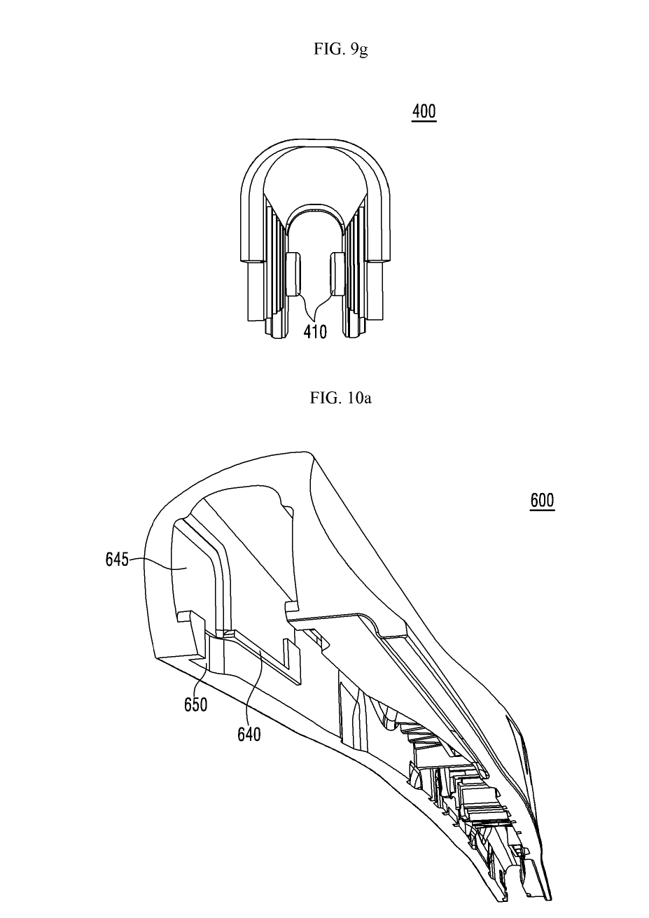

FIG. 8 shows enlarged views of a main lever 300, a spacer clip 400 and a central cover 600 in the wiper blade 10 shown in FIG. 2.

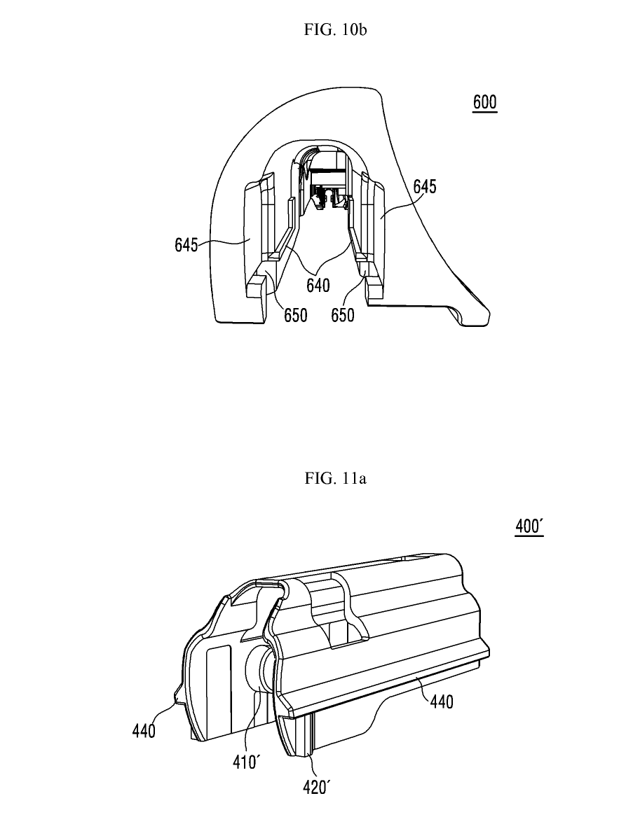

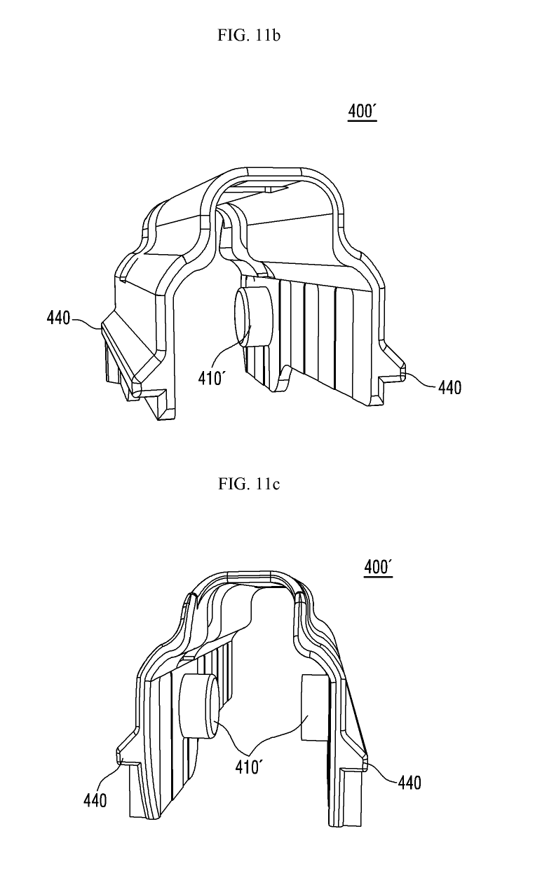

FIGS. 9a to 9g show enlarged views of the spacer clip 400 according to the first example. FIGS. 10a to 10b show enlarged views of the central cover 600 according to the first example.

Hereafter, the coupling structure between the main lever 300 and the central cover 600 will be described with reference to FIGS. 8, 9a to 9g, 10a and 10b.

The main lever 300 may include the second through-hole 350. The spacer clip 400 may include an inner protrusion 410, a catching protrusion 420, and an outer protrusion 430. The central cover 600 may include a pair of inner ribs 640, a pair of open grooves 645, and a pair of catching grooves 650.

A pair of the right and left second through-holes 350 of the main lever 300 may be formed on sides of the main lever 300 respectively. The second through-hole 350 may have a circular shape. The main lever 300 may be made of a resin material. The inner protrusion 410 of the spacer clip 400 may protrude from the inner surface of the spacer clip 400. The inner protrusion 410 may have a circular shape and a size corresponding to that of the second through-hole 350. More specifically, the inner protrusion 410 may have a diameter which is less than that of the second through-hole 350 and allows the inner protrusion 410 to be inserted into the second through-hole 350 without difficulty in pivoting. The spacer clip 400 may be made of a resin material and have a certain rigidity. The inner protrusion 410 is inserted into the second through-hole 350, so that the spacer clip 400 is inserted into the main lever 300. Both the main lever 300 and the spacer clip 400 may be made of a resin material. Therefore, it is possible to provide a wiper blade having an improved assemblability and a lighter weight.

The spacer clip 400 may be coupled to the central cover 600 with coupling to the main lever 300. The central cover 600 may include a pair of the right and left inner ribs 640 formed on the inside of the central cover 600 to extend in the longitudinal direction of the central cover 600. Here, the inner rib 640 may have the same length as that of the spacer clip 400. One end of the inner rib 640 may extend upwardly. More specifically, a portion of the inner rib 640, which is closer to the center of the wiper blade 10, may extend upwardly. The open groove 645 may be formed on and outside the other end of the inner rib 640. The open groove 645 may be formed to a certain depth from the inside of the central cover 600, in which the rib is located. The open groove 645 may be opened at the end of the central cover 600.

The catching groove 650 may be formed under and outside the other end of the inner rib 640. The catching groove 650 may be formed to a certain depth from the inside of the central cover 600, in which the inner rib 640 is located. The catching groove 650 may not be opened at the end of the central cover 600.

The spacer clip 400 may include the outer protrusion 430 and the catching protrusion 420. The outer protrusion 430 has as shape protruding outward from the spacer clip 400 and has a size and a shape corresponding to those of the open groove 645 of the central cover 600. The catching protrusion 420 has a shape protruding outward from the spacer clip 400 and has a size corresponding to that of the catching groove 650 of the central cover 600.

The catching protrusion 420 may have a shape having a degree of projection, which is increased toward the end of the spacer clip 400 from the center of the wiper blade 10. The catching protrusion 420 may be shrunk by a constant pressure and move inwardly. When the constant pressure is removed, the catching protrusion 420 may be restored to the original state. Therefore, the catching protrusion 420 may be inserted into the catching groove 650.

The spacer clip 400 may be inserted into the inside of the central cover 600, with coupling to the main lever 300. Since the external shape of the spacer clip 400 corresponds to the internal shape of the central cover 600, the spacer clip 400 may be inserted into the inside of the central cover 600. The spacer clip 400 may be inserted within and coupled to the central cover 600. More specifically, the spacer clip 400 may be inserted in a sliding manner into the inside of the central cover 600 such that the lower portion of the spacer clip 400 is located on the inner rib 640 of the central cover 600. Here, the movement of the spacer clip 400 toward the center of the wiper may be limited by the extended end of the inner rib 640. Also, the movement of the outer protrusion 430 toward the center of the wiper blade 10 may be limited by the open groove 645, and the catching protrusion 420 may be inserted into the catching groove 650. As a result, when the spacer clip 400 is completely inserted into the inside of the central cover 600, the spacer clip 400 is not inserted into the inside of the central cover 600 any more. Also, when the catching protrusion 420 is inserted into the catching groove 650, the movement of the spacer clip 400 in an opposite direction to the center of the wiper may be limited. That is, the spacer clip 400 is able to maintain the coupling to the central cover 600 at the position where the spacer clip 400 is completely inserted into the inside of the central cover 600.

Since only one spacer clip 400 is used to couple the central cover 600 to the main lever 300, the number of the parts for manufacturing the wiper blade 10 is decreased as a whole, and thus, it is possible to accomplish the simplification of the manufacturing process and improvement of the manufacturing efficiency. Further, the spacer clip 400 is inserted between the central cover 600 and the main lever 300, thereby increasing the strength of the wiper blade 10, strengthening the coupling and reducing a gap created between the central cover 600 and the main lever 300. Also, it is possible to increase a resistance to both a bending moment and a torsional moment. Also, since the main lever 300 may be made by a injection-molding method, the main lever 300 can be manufactured in various forms.

Since the main lever 300 and the spacer clip 400 are made of a resin material, the total weight of the wiper blade 10 can be reduced. Also, because the product can be integrally molded, the number of the parts is reduced. The manufacturing process becomes simpler and manufacturing cost is reduced.

3. The Coupling of the Main Lever 300 and a Central Cover 600′ in Accordance with a Second Example

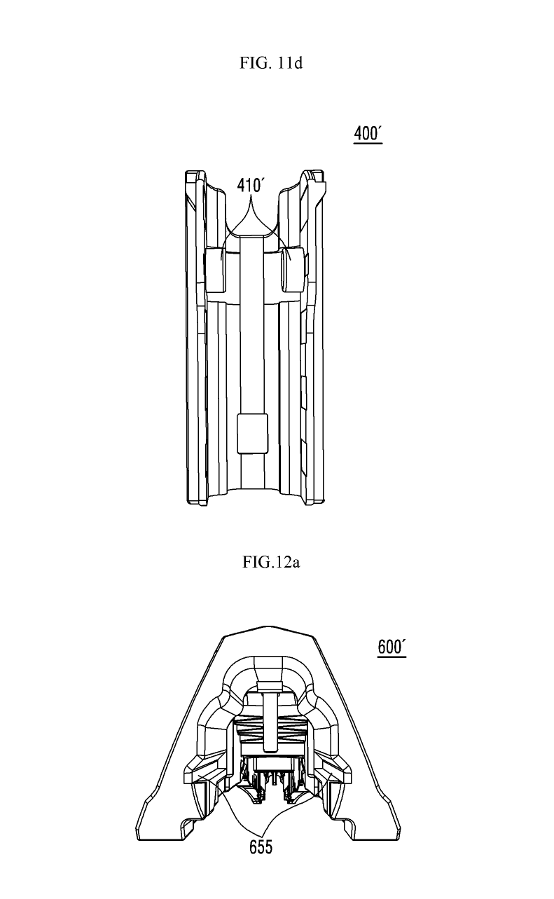

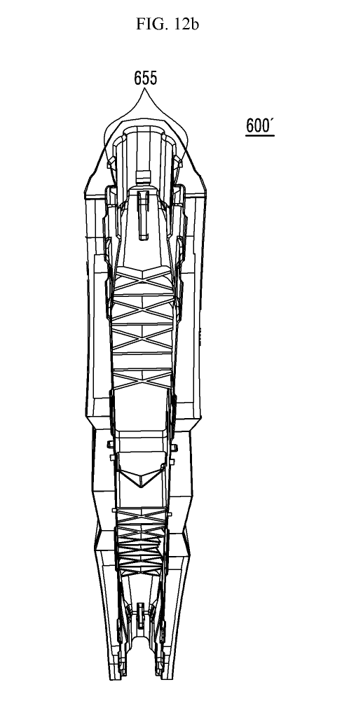

FIGS. 11a to 11d show enlarged views of a spacer clip 400′ according to a second example. FIGS. 12a to 12d show enlarged views of a central cover 600′ according to the second example.

Hereafter, the coupling structure between the main lever 300 and the central cover 600′ will be described with reference to FIGS. 8, 11a to 11d, and 12a and 12b.

The main lever 300 may include the second through-hole 350. The spacer clip 400′ may include an inner protrusion 410′, a catching protrusion 420 and a pair of outer ribs 440. The central cover 600′ may include a pair of catching grooves 650′, and a pair of slits 655.

A pair of the second through-holes 350 of the main lever 300 may be formed on the right and left sides of the main lever 300 respectively. The second through-hole 350 may have a circular shape. The main lever 300 may be made of a resin material. The inner protrusion 410′ of the spacer clip 400′ may protrude from the inner surface of the spacer clip 400′. The spacer clip 400′ may have a circular shape and a size corresponding to that of the second through-hole 350. More specifically, the inner protrusion 410′ may have a diameter which is less than that of the second through-hole 350 and allows the inner protrusion 410′ to be inserted into the second through-hole 350 without difficulty in pivoting. The spacer clip 400′ may be made of a resin material and have a certain rigidity. The inner protrusion 410′ is inserted into the second through-hole 350, so that the spacer clip 400′ is coupled to the main lever 300. Both the main lever 300 and the spacer clip 400′ may be made of a resin material. Therefore, it is possible to provide a wiper blade having an improved assemblability and a lighter weight.

The spacer clip 400′ may be coupled to the central cover 600′ with coupling to the main lever 300. The central cover 600′ may include a pair of the right and left slits 655 formed on the inside of the central cover 600′ to extend in the longitudinal direction of the central cover 600′. Here, the slit 655 may have the same length as that of the spacer clip 400′.

The catching groove 650′ may be formed inside the central cover 600′. The catching groove 650′ may be formed under the slit 655. The catching groove 650′ may be formed to a certain depth from the inside of the central cover 600′, in which the slit 655 is located.

The spacer clip 400′ may include a pair of the right and left catching protrusions 420′ which protrudes outwardly from the outer surface of the spacer clip 400′, and a pair of the right and left outer ribs 440 which extends from the outer surface in the longitudinal direction of the spacer clip 400′. The catching protrusion 420′ may have a size corresponding to that of the catching groove 650′ of the central cover 600′.

The catching protrusion 420′ may have a shape having a degree of projection, which is increased toward the end of the spacer clip 400′ from the center of the wiper blade 10. The catching protrusion 420′ may be shrunk by a constant pressure and move inwardly. When the constant pressure is removed, the catching protrusion 420′ may be restored to the original state. Therefore, the catching protrusion 420′ may be inserted into the catching groove 650′.

The spacer clip 400′ may be inserted into the inside of the central cover 600′, with coupling to the main lever 300. Since the external shape of the spacer clip 400′ corresponds to the internal shape of the central cover 600′, the spacer clip 400′ may be inserted into the inside of the central cover 600′. The spacer clip 400′ may be coupled to the central cover 600′ in a state of being inserted into the inside of the central cover 600′. More specifically, the spacer clip 400′ may be inserted in a sliding manner into the inside of the central cover 600′ such that the outer rib 440 of the spacer clip 400′ is located in the slit 655 of the central cover 600′. Here, since the slit 655 of the central cover 600′ has the same length as that of the spacer clip 400′, the movement of the spacer clip 400′ toward the center of the wiper may be limited. Also the catching protrusion 420′ of the spacer clip 400′ may be inserted into the catching groove 650′. As a result, when the spacer clip 400′ is completely inserted into the inside of the central cover 600′, the spacer clip 400′ is not inserted into the inside of the central cover 600′ any more. Also, when the catching protrusion 420′ is inserted into the catching groove 650′, the movement of the spacer clip 400′ in an opposite direction to the center of the wiper may be limited. That is, the spacer clip 400′ is able to maintain the coupling to the central cover 600′ at the position where the spacer clip 400′ is completely inserted into the inside of the central cover 600′. The main lever 300, the spacer clip 400′, and the central cover 600′ may be made of a resin material.

Since only one spacer clip 400′ is used to couple the central cover 600′ to the main lever 300, the number of the parts for manufacturing the wiper blade 10 is decreased as a whole, and thus, it is possible to accomplish the simplification of the manufacturing process and improvement of the manufacturing efficiency. Further, the spacer clip 400′ is inserted between the central cover 600′ and the main lever 300, thereby increasing the strength of the wiper blade 10, strengthening the coupling and reducing a gap created between the central cover 600′ and the main lever 300. Also, it is possible to increase a resistance to both a bending moment and a torsional moment. Also, since the main lever 300 may be injection-molded, the main lever 300 can be manufactured in various forms.

Since the main lever 300 and the spacer clip 400′ are made of a resin material, the total weight of the wiper blade 10 can be reduced. Also, because the product can be integrally molded, the number of the parts is reduced. The manufacturing process becomes simpler and manufacturing cost is reduced.

### MODIFIED EXAMPLE

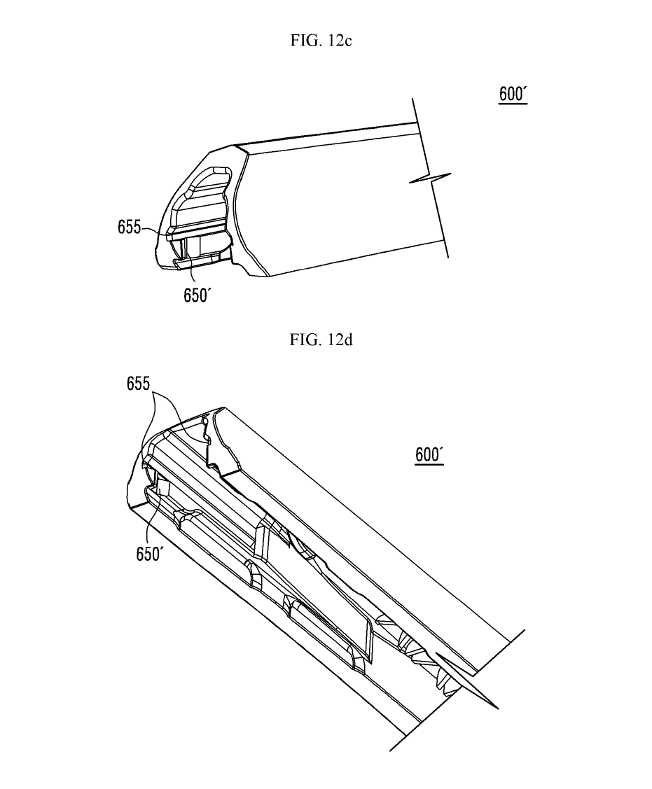

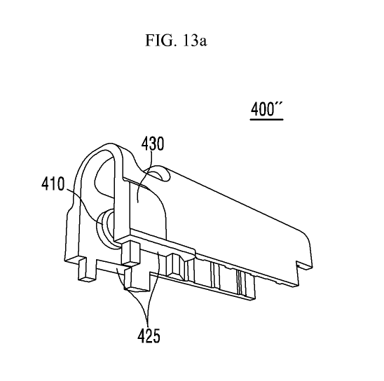

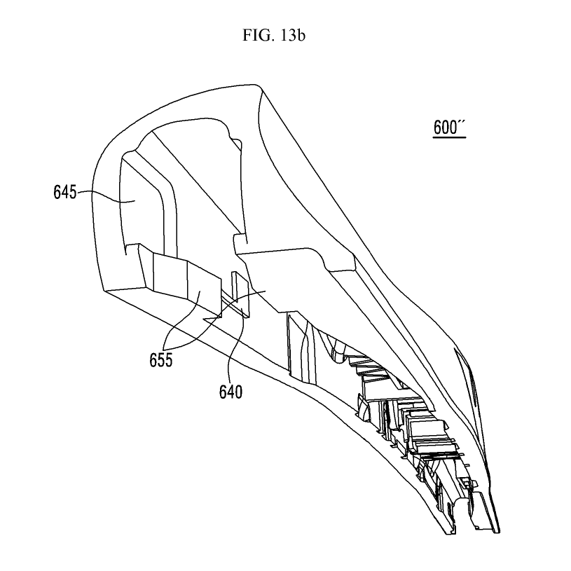

FIG. 13a shows an enlarged view of a first modified example 400″ of the spacer clip according to the first example.

The spacer clip 400″ according to the first modified example may include a catching groove 425. The spacer clip 400″ according to the first modified example may include the catching groove 425 at the position of the catching protrusion 420 of the spacer clip 400 shown in FIGS. 9a to 9g.

FIG. 13b shows an enlarged view of a first modified example 600″ of the central cover according to the first embodiment.

The central cover 600″ according to the first modified example may include a catching protrusion 660 which is formed under and outside the other end of the inner rib 640. The catching protrusion 660 may have a shape having a degree of projection, which is increased toward the center of the central cover 600″ from the end of the wiper blade 10.

FIG. 13c is a view showing a coupling relationship between the spacer clip 400″ of FIG. 13a and the central cover 600″ of FIG. 13b.

As shown in FIG. 13c, the catching protrusion 660 of the central cover 600″ of FIG. 13b is inserted into the catching groove 425 of the spacer clip 400″ of FIG. 13a, so that the spacer clip 400″ of FIG. 13a may be coupled to the central cover 600″ of FIG. 13b.

Though FIGS. 13a to 13c show the spacer clip 400 according to the first embodiment, the modified example of the central cover 600 and the coupling relationship between them, the spacer clip 400′ and central cover 600′ according to the second embodiment can be coupled to each other with the same structure.

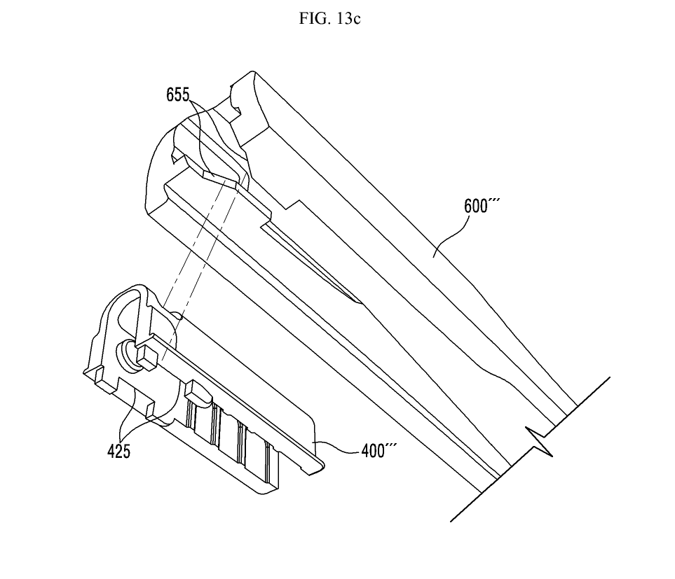

FIG. 14 is a view showing a coupling relationship between a main lever 300′″ and a spacer clip 400′″ according to a second modified example of the first embodiment.

The main lever 300′″ according to the second modified example of the first embodiment may further include a pair of right and left outer protrusions 365 formed on the outside of the main lever 300′″. Also, the spacer clip 400′″ according to the second modified example of the first embodiment may further include a pair of right and left through-holes 435 formed in the sides of the spacer clip 400′″. The main lever 300′″ can be coupled to the spacer clip 400′″ by inserting the outer protrusion 365 of the main lever 300′″ into the through-hole 435 of the spacer clip 400′″.

Though FIG. 14 shows the main lever 300′″ according to the first embodiment, the modified example of the spacer clip 400′″ and the coupling relationship between them, the spacer clip 400′ and central cover 600′ according to the second embodiment can be coupled to each other with the same structure.

The spacer clip according to the first and second embodiments may include all configurations shown in FIGS. 13a and 14. That is, the spacer clip may include both the catching groove 425 and the through-hole 435.

### Wiper Blade 10 According to the Second Embodiment

### 1. Overall Structure

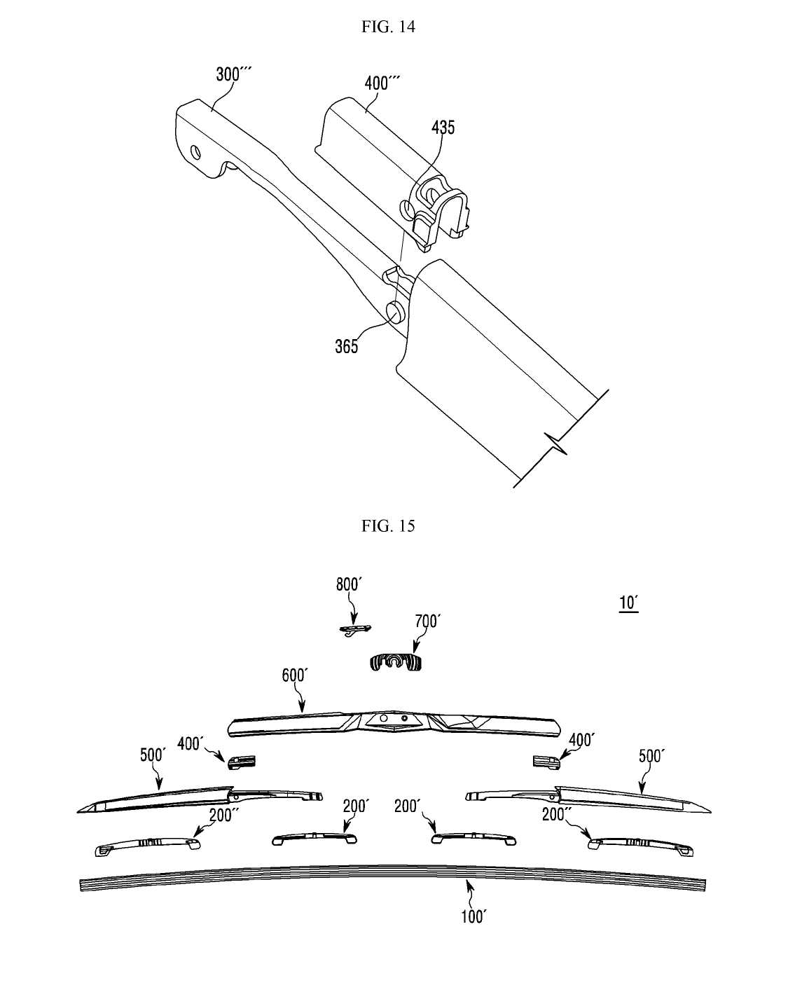

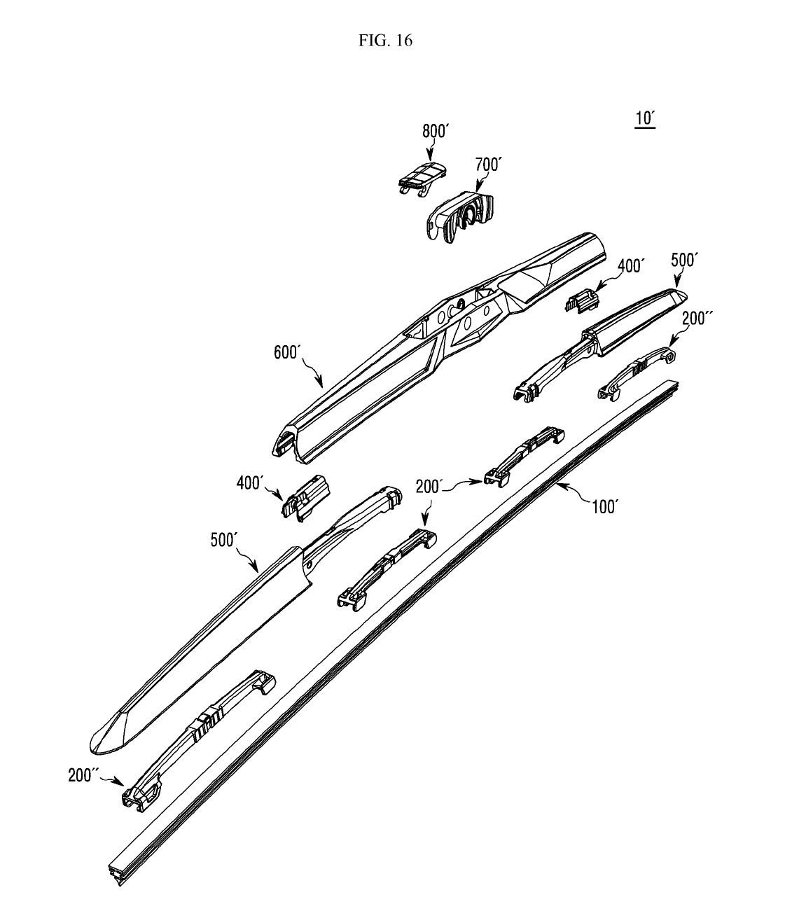

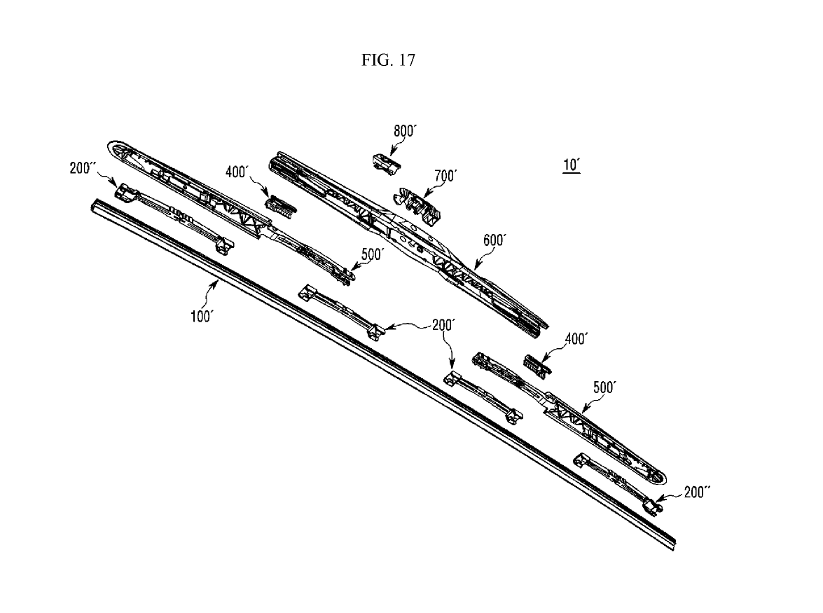

FIG. 15 is an exploded from view of a wiper blade 10′ according to the second embodiment. FIG. 16 is a top perspective view of the wiper blade 10′ according to the second embodiment. FIG. 17 is a bottom perspective view of the wiper blade 10′ according to the second embodiment.

Hereafter, the overall structure and each component of the wiper blade 10′ according to the second embodiment will be described in detail with reference to FIGS. 15 to 17.

The wiper blade 10′ according to the second embodiment distinguished from the wiper blade 10 according to the first embodiment will be described.

The wiper blade 10′ according to the second embodiment may further include a pair of auxiliary levers 200″. A pair of the auxiliary levers 200″ may be made of a resin material having high strength. Eight points of a wiper strip 100′ of the wiper blade 10′ according to the second embodiment may be supported as a whole by two pairs of the auxiliary levers 200″. As such, the pressing force applied to the wiper strip 100′ can be evenly distributed to the eight points. Accordingly, the glass surface can be cleaned by the pressing force applied to the wiper strip 100′.

Also, in the wiper blade 10′ according to the second embodiment, a side cover 500′ may be in a state of being coupled to the main lever 300′. Therefore, the total number of the parts is reduced and a lower manufacturing cost can be obtained. Since the side cover 500′ is formed integrally with the main lever 300′, it is possible to implement the wiper blade 10′ having increased strength as a whole.

As with the wiper blade 10 according to the first embodiment, in the wiper blade 10′ according to the second embodiment, the main lever 300′ may be coupled to the central cover 600′. More detailed coupling structure can be found by the coupling structure between the main lever 300 and the central cover 600 in the wiper blade 10 according to the first embodiment.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the embodiments. Further, the embodiments may be changed and modified in various ways, without departing from the essential features of the embodiments, by those skilled in the art. That is, the components described in detail in the embodiments of the present invention may be modified. Further, differences due to the modification and application should be construed as being included in the scope and spirit of the embodiment, which is described in the accompanying claims.

What is claimed is:

1. A wiper blade comprising:
a wiper strip which wipes a glass surface;
at least one pair of auxiliary levers which supports the wiper strip;
a pair of resin-made main levers which is coupled to the auxiliary levers and comprises a pair of right and left second through-holes formed in a side thereof;
a central cover which is coupled to the main lever, is connected to a wiper arm and comprises a pair of right and left inner ribs extending from the inside of the central cover in a longitudinal direction of the central cover and having one end closer to the center of the wiper blade, the one end extending upwardly; and
a resin-made spacer clip which is inserted between the main lever and the central cover and comprises a pair of right and left inner protrusions formed therewithin,
wherein, in a state where a lower portion of the spacer clip is located on the inner rib, the spacer clip is coupled to the central cover,
wherein, as the inner protrusion is inserted into the second through-hole, the spacer clip is coupled to the main lever,
and wherein movement of the spacer clip toward the center of the wiper blade is limited by the extended end of the inner rib.

2. The wiper blade of claim 1,
wherein the central cover comprises a pair of right and left catching grooves formed under and outside the other end of the inner rib,
wherein the spacer clip comprises a pair of right and left catching protrusions which has a shape protruding outward from the spacer clip and is inserted into the catching groove,
and wherein, in a state where the lower portion of the spacer clip is located on the inner rib, the spacer clip is coupled to the central cover as the catching protrusion is inserted into the catching groove.

3. The wiper blade of claim 2,
wherein the central cover further comprises a pair of right and left open grooves formed on and outside the other end of the inner rib,
and wherein the spacer clip further comprises a pair of right and left outer protrusions which has a shape protruding outward from the spacer clip and moves limitedly toward the center of the wiper blade by the open groove.

4. The wiper blade of claim 3, wherein the catching protrusion is formed to have a degree of projection, which is increased toward an end of the spacer clip from the center of the wiper blade.

5. The wiper blade of claim 1,
wherein the central cover comprises a pair of right and left catching protrusions which has a protruding shape and is formed outwardly and downwardly from the other end of the inner rib,
wherein the spacer clip comprises a pair of right and left catching grooves into which the catching protrusion is inserted,
and wherein, in a state where the lower portion of the spacer clip is located on the inner rib, the spacer clip is coupled to the central cover as the catching protrusion is inserted into the catching groove.

6. The wiper blade of claim 5,
wherein the central cover further comprises a pair of right and left open grooves formed on and outside the other end of the inner rib,
and wherein the spacer clip further comprises a pair of right and left outer protrusions which has a shape protruding outward from the spacer clip and moves limitedly toward the center of the wiper blade by the open groove.

7. The wiper blade of claim 6, wherein the catching protrusion is formed to have a degree of projection, which is increased toward an end of the spacer clip from the center of the wiper blade.

8. A wiper blade comprising:
a wiper strip which wipes a glass surface;
at least one pair of auxiliary levers which supports the wiper strip;
a pair of resin-made main levers which is coupled to the auxiliary levers and comprises a pair of right and left second through-holes formed in a side thereof;
a central cover which is coupled to the main lever, is connected to a wiper arm and comprises a pair of right and left inner ribs extending from the inside of the central cover in a longitudinal direction of the central cover; and
a resin-made spacer clip which is inserted between the main lever and the central cover and comprises a pair of right and left outer ribs formed to extend from an outer surface of the spacer clip in a longitudinal direction of the spacer clip and a pair of right and left inner protrusions formed therewithin,
wherein, in a state where the outer rib is inserted into the slit, the spacer clip is coupled to the central cover,
and wherein, as the inner protrusion is inserted into the second through-hole, the spacer clip is coupled to the main lever.

9. The wiper blade of claim 8,
wherein the central cover comprises a pair of right and left catching grooves formed under and outside the other end of the inner rib,
wherein the spacer clip comprises a pair of right and left catching protrusions which has a shape protruding outward from the spacer clip and is inserted into the catching groove,
and wherein, in a state where the outer rib is inserted into the slit, the spacer clip is coupled to the central cover as the catching protrusion is inserted into the catching groove.

10. The wiper blade of claim 9, wherein the catching protrusion is formed to have a degree of projection, which is increased toward an end of the spacer clip from the center of the wiper blade.

11. The wiper blade of claim 8,
wherein the central cover comprises a pair of right and left catching protrusions which has a protruding shape and is formed outwardly and downwardly from the other end of the inner rib,
wherein the spacer clip comprises a pair of right and left catching grooves into which the catching protrusion is inserted,
wherein, in the state where the outer rib is inserted into the slit, the spacer clip is coupled to the central cover as the catching protrusion is inserted into the catching groove.

12. A wiper blade comprising:
a wiper strip which wipes a glass surface;
at least one pair of auxiliary levers which supports the wiper strip;
a pair of resin-made main levers which is coupled to the auxiliary levers and comprises a pair of right and left outer protrusions formed on the outside thereof;
a central cover which is coupled to the main lever, is connected to a wiper arm and comprises a pair of right and left slits extending from the inside of the central cover in a longitudinal direction of the central cover, and comprises a pair of right and left catching grooves formed therewithin; and
a resin-made spacer clip which is inserted between the main lever and the central cover and comprises a pair of right and left outer ribs formed to extend from an outer surface of the spacer clip in a longitudinal direction of the spacer clip, comprises a pair of right and left through-holes formed on sides thereof, and comprises a pair of right and left catching protrusions which protrudes outwardly from the outer surface of the spacer clip,
wherein, in a state where the outer rib is inserted into the slit, the spacer clip is coupled to the central cover as the catching protrusion is inserted into the catching groove,
and wherein, as the outer protrusion is inserted into the through-hole, the spacer clip is coupled to the main lever.
